(19) United States
(12) Patent Application Publication
(10) Pub. No.: US 2010/0251695 A1
(43) Pub. Date: Oct. 7, 2010

(54) ROCKET ENGINE FOR USE WITH AERODYNAMIC FUEL RIBBON, AND FUEL RIBBON FOR ROCKET AND METHOD

(76) Inventor: David Lloyd Summers, Chicago, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/417,340

(22) Filed: Apr. 2, 2009

(51) Int. Cl. F02K 9/08

(52) U.S. Cl. 60/253

(57) ABSTRACT

A rocket engine for manned or unmanned space flight and atmospheric flight uses an elongated fuel structure that is external to the combustion chamber and that is fed into the combustion chamber during operation of the rocket. The elongated fuel structure includes propellant elements and may include coolant elements as well. The elongated fuel structure of one embodiment is a ribbon and a wide ribbon may be formed of plural side-by-side ribbon sections. The wide ribbon is cut into separate ribbon sections and is fed between two opposed pinion gears of a fuel injector. The fuel injector has multiple pairs of opposed pinion gears forming multiple stages of the injector, which seal the engine from escaping gases while permitting the elongated fuel structure to be drawn into the engine. The injector has a cutting wheel at the outlet to cut open the coolant and propellant bodies in the ribbon. The propellant ribbon has an outer slow burning layer and an inner fast burning layer. Gas pressure generated by burning the propellant in the combustion chamber of the rocket engine drives the engine. The coolant to the engine is provided from the coolant elements.

### BACKGROUND OF THE INVENTION

1. Field of the Invention

The present invention relates generally to an apparatus and method for fueling a rocket with a solid propellant and to a rocket engine fueled by a solid propellant as well as to a rocket fuel structure.

2. Description of the Related Art

The present invention provides an improvement over the invention disclosed in U.S. patent application Ser. No. 12/247,656, filed Oct. 8, 2008, which is incorporated herein by reference.

Rocket engines fueled by a solid propellant, so-called solid fuel rockets, commonly have a fuel housing within which is one or more bodies of combustible solid that is ignited to drive hot gasses from a rearwardly directed nozzle. Once the combustible solid fuel is ignited, it generally must burn completely without the possibility of shut down or control. Regulation of the burn rate is accomplished by providing different fuel formulas at different locations within the housing. In flight regulation is not possible.

Rockets are currently extremely expensive to operate, limiting their applications to specialized fields such as space and orbital work. A much larger market can be realized if a rocket's operational cost can be lowered. For example a small aircraft capable of flying people from Chicago to Beijing in 45 minutes would appeal to a large market if available at reasonable costs.

Rocket's costs are primarily related to complexity and size. The smaller a rocket, the less it costs to develop and fly. This is due largely to a decrease in complexity, but also due to a decrease in the “worst case” disaster severity—the safety requirements for a 747 are much larger than those of a Cessna two-seater.

As complexity increases cost increases exponentially, as each part needs to be designed, tested, and maintained. In addition, each part is interrelated to all the other parts. If the heat shielding is too massive, you need more propellant, which cascades to larger engines, bigger wings, etc. leading to a still larger heat shield. So in addition to a lower parts count, the parts should be less interrelated to achieve lower costs.

Solid rockets are by far the simplest forms of rockets. They do not require finely tuned injectors, propellant mixing, pumping, storage and movement in tanks, hard starts, etc. Historically, solid rockets have been held back by their lower performance—primarily due to the entire propellant supply being necessarily contained inside the engine itself. Solid rockets typically also have lower Isp (specific impulse—a measure of engine propellant efficiency) than liquid propellants, and therefore require higher mass fractions to achieve the same total impulse.

Making a rocket that can achieve a large change in velocity is very difficult. The basic governing equation is v=Isp·9.8·ln(MR); where v is the change in velocity, Isp is a measure of the rocket engine's thrust performance, and MR is the mass ratio (full stage mass divided by the empty stage mass). Rockets typically have an Isp between 300 and 450 seconds, and a mass ratio of about 10. Unfortunately, higher Isp engines tend to have lower mass ratios—so achieving a stage velocity change of 9,000 m/s or more has been difficult to achieve. Maximum Isp is limited primarily by available energy in the fuel, and so is difficult to increase. A solid fuel feeder increases stage velocity by allowing extremely high mass ratio stages, instead of focusing on Isp.

Essentially, stage mass ratio is governed by two things: the engine's thrust to weight ratio, and the tank mass fraction. Rocket engines inherently have large thrust ratios—but tank mass fraction is difficult to make acceptable. First the tanks must typically hold cryogenic fuels, which limits the materials that can be used while building them. Second the highest Isp fuels have low density, and so require larger tanks volumes for a given mass. Third, most rocket engines require high inlet pressures, so the tanks must hold high pressures.

Making these tanks lightweight virtually requires low design margins. This makes them very fragile—if they are taken just a little off optimum, they rupture. When they rupture, the high internal pressure forces the fuel out of the tank and into the surrounding area. Typically, this force (and the rocket engine burning below it!) ignites the propellant and destroys the rocket and anything nearby.

As an example of the problem mass ratio poses during launch vehicle design, consider: The rocket's performance can be defined as:

delta−v=Isp·ln(1+Mₚᵣₒₚₑₗₗₐₙₜ/[M_{engine}+Mₜₐₙₖₛ+M_{heatshield}+M_{structure}+M_{fixed}+M_{payload}+Mₚᵣₒₚₑₗₗₐₙₜ])

Where:

M_{engine}=ThrustToWeightRatio·[M_{engine}+Mₜₐₙₖₛ+M_{heatshield}+M_{structure}+M_{fixed}+M_{payload}+Mₚᵣₒₚₑₗₗₐₙₜ]

Mₜₐₙₖₛ=F(Isp, Mₚᵣₒₚₑₗₗₐₙₜ)

M_{heatshield}=F(Tank Size)

Because all these variables are interdependent, a solution is extremely hard to find. As the design misses its mass targets, an increase must be made in the propellant load—which requires increased engine mass (which requires yet more fuel), and increased tank mass (which requires larger and heavier heat shields, and heavier structure). These interdependencies make large delta-v vehicle designs very risky—small subsystem performance prediction errors cause large vehicle performance misses.

It is possible to avoid all of these problems by using a solid propellant injected into a rocket engine. First, no tank is required—a solid fuel can be its own tank. This means that the mass ratio can be practically as high as the engine thrust ratio. Solid fuels are not typically cryogenic, so they require no special handling or materials. Because the solid fuel is not pressurized at all, there is no equivalent to a tank rupture. The fuel can (and should) be designed to not burn well at atmospheric pressure—so a worst case crash or failure means a slowly burning rope-like mass slumps to the ground. Refueling is also faster than with liquid fuels—instead of transferring fuels between containers, the fuel end is simply threaded into the engine.

Further, the interdependencies in vehicle design are broken. Adding propellant only requires a larger engine. Since there is no tank, the heat shield design can remain unchanged. If the propellant is self supporting (or is hanging in the rear of the vehicle), no additional structure is needed for the extra propellant loads. This makes vehicle design far easier, and makes the minimum vehicle scale far smaller as well.

### SUMMARY OF THE INVENTION

The present invention provides solid rocket fuel configuration as an elongated fuel structure having a plurality of solid fuel bodies that are provided sequentially to a combustion chamber of a solid fuel rocket. The elongated fuel structure of a preferred embodiment has a shape of a rack of a rack and pinion gear pair, in other words an elongated body shaped with gear teeth. The rack shaped elongated body had gear teeth on two opposite surfaces. The elongated fuel structure preferably has a flat configuration and may have plural elongated fuel structures arranged side-by-side.

In an embodiment, the elongated fuel structure includes a plurality of coolant chambers disposed along the elongated body which contain coolant for use during operation of the rocket engine. The coolant chambers are opened upon being fed into the rocket engine to release the coolant for use in cooling components of the rocket engine. In a preferred embodiment, the elongated structure also includes gas generators associated with the coolant chambers for expelling the coolant and for generating gas to drive the in feed of the fuel to the combustion chamber. The elongated fuel structure provides particular benefit when configured as a ribbon containing alternating propellant elements and coolant.

Another aspect of the present invention provides a feed apparatus for feeding an elongated fuel structure containing solid rocket fuel into a combustion chamber of a rocket. In one embodiment, the feed apparatus includes two opposed wheels turning in opposite directions and between which is fed the elongated fuel body. The preferred wheels have shaped surfaces to accommodate the solid fuel bodies disposed at spaced intervals along the elongated structure. Embodiments that utilize an elongated fuel containing structure including coolant chambers also have shaped surfaces to accommodate the coolant chambers provided in the elongated structure.

The fuel ribbon is preferably coated with a coating to slow burning of the solid fuel initially and allow fast burning of the fuel thereafter. The fuel elements are connected to one another by a flexible material, such as plastic. Multiple ribbons may be connected side-by-side to form a wide, flat fuel ribbon structure.

### BRIEF DESCRIPTION OF THE DRAWINGS

FIG. 1 is a side perspective view of an elongated fuel structure, or ribbon, having solid fuel bodies and coolant/gas generator cylinders in alternating spaced arrangement along its length;

FIG. 2 is a top perspective view of a solid propellant body and coolant cylinder portion of the ribbon of FIG. 1;

FIG. 3 is a top plan view of the ribbon with the solid fuel elements and gas generator elements and a battery;

FIG. 4 is a side cross sectional view of a propellant pump portion of the rocket engine for intake of the elongated fuel structure of FIG. 1;

FIG. 5 is a side cross sectional view of the propellant pump portion of FIG. 4 from a direction perpendicular to the view of FIG. 4;

FIG. 6 is an enlarged partial perspective view of a nozzle mounting portion of the rocket engine according to the principles of the present invention;

FIG. 7 is a side view of the present rocket engine including a combustion chamber, propellant pump and nozzle mounting;

FIG. 8 is a side cross sectional view of the present rocket engine showing a combustion chamber and propellant pump;

FIG. 9 is a side view of the rocket engine with the combustion chamber, thrust nozzles, and propellant pump, and an elongated fuel structure being fed into the propellant pump;

FIG. 10 is an enlarged cross sectional view of the propellant pump showing the pump wheels engaging a coolant chamber of the elongated fuel structure;

FIG. 11 is an enlarged cross sectional view of the propellant pump of FIG. 10 showing the pump wheels engaging a solid propellant body;

FIG. 12 is a side view of an aircraft using the present rocket engine;

FIG. 13 is a side cross sectional view of a single injector of a second embodiment;

FIG. 14 is a side view of a single injector of the second embodiment;

FIG. 15 is a plan view of an assembly of many engines of the second embodiment arranged side-by-side;

FIGS. 15a, 15b, 15c and 15d are enlarged views of portions of the rocket engines of FIG. 15;

FIG. 16 is a perspective view of a rocket plane that uses the rocket engines of the second embodiment;

FIG. 17 is an end view of the injector according to the second embodiment;

FIG. 18 is a top view of the injector of FIG. 17;

FIG. 19 is a side view of the injector of FIG. 17 showing a fuel ribbon feeding into the injector;

FIG. 20 is a side view of the injector of FIG. 17 without the fuel ribbon;

FIG. 21 is a perspective view of side-by-side engines being supplied with side-by-side fuel ribbon sections;

FIG. 22 is a side view of the fuel ribbon of the second embodiment; and

FIG. 23 is a perspective view of the fuel ribbon of the second embodiment.

### DETAILED DESCRIPTION OF THE PREFERRED EMBODIMENTS

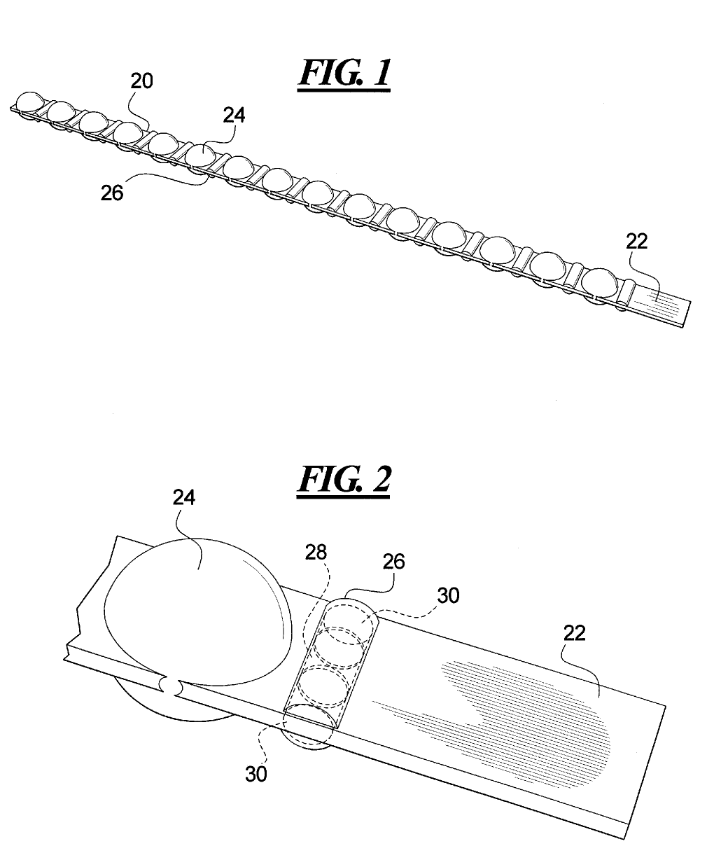

In FIG. 1 is shown an elongated fuel structure 20 for fueling a rocket engine. The elongated fuel structure includes a ribbon formed of a ribbon housing 22, for example, of nylon, a series of spherical propellant elements 24 mounted along the ribbon housing 22 and a series of coolant and gas generator elements 26 mounted along the ribbon housing 22 between the propellant elements 24.

In FIG. 2, a portion of the ribbon housing 22 is a flattened body. In a preferred embodiment, a nylon fabric strip has the propellant elements 24 affixed thereto, such as by an adhesive. The propellant elements 24 are formed into hemispheres and two such hemispheres are affixed to the nylon strip on opposite sides to form a spherical propellant element. A covering or coating, such as a plastic or rubber paint or coating, is applied over the propellant elements 24 as possibly over the fabric strip as well. The covering or coating encases and seals the propellant material and aids in forming a seal with the shaped recesses in the pump wheels, as will be described later. An alternative embodiment provides that the ribbon is formed of two elongated strips of ribbon material, such as a woven or non-woven fabric, that are joined to one another to hold the propellant elements 24 and coolant and gas generator elements 26 in the elongated fuel structure 20. The strips of ribbon material encase or at least partially encase the elements 24 and 26. Other means of holding the elements 24 and 26 in the ribbon 22 are also possible and are within the scope of the present invention.

The propellant element 24 is a sphere of a solid rocket fuel that has a diameter substantially equal to or slightly wider than the width of the ribbon 22. The sphere 24 is held in the ribbon 22 by being encased or partially encased within the material of the ribbon 22. It is also foreseeable that the propellant element 24 may be of some other shape and may be held in the elongated fuel structure by some other means. For example, the propellant element 24 may be of a cylindrical shaped having an axis generally extended along the length of the ribbon, or may be of a capsule shape having generally hemispherical ends and a cylindrical mid portion. Any shape that passes between the rollers of the pump and through the pump exit tube or throat into the combustion chamber while maintaining a seal condition is possible.

The coolant and gas generator element 26 is a cylindrical body having a gas generator 28 between two coolant chambers 30. Activation of the gas generator 28 causes gas to be generated that is expelled into the rocket engine. As will be shown, the gas generator expels the gas into a high pressure area of the rocket engine. The expelling gas also forces the coolant out of the coolant chambers 30 into rocket engine, in particular, into the high pressure area, where the coolant is collected and used for cooling portions of the rocket engine during operation.

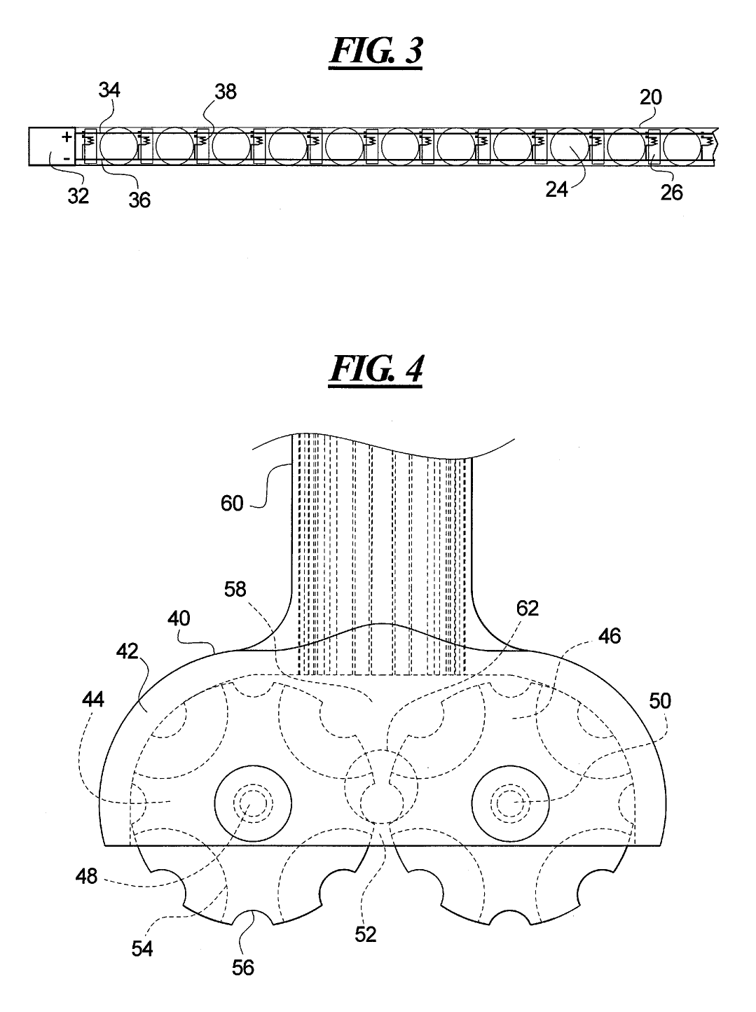

FIG. 3 shows that the elongated fuel structure 20 with the arrangement of coolant and gas generator elements 26 and propellant elements 24 along its length. A power source 32, such as a battery, is provided as part of or is connected to the elongated fuel structure 20. Conductors in the form of wires 34 and 36 run the length of the elongated fuel structure 20. At or near each gas generator element 26 is provided a switch 38. The switch 38 is operable to supply power from the power source 32 to the respective gas generator elements 26. By supplying power to the gas generator 26, the switch activates the gas generator to cause the gas and the coolant to be ejected.

The elongated fuel structure may have many other configurations and constructions as will be apparent to those of skill in the art. A possible alternative embodiment provides the propellant in the elongated fuel structure, but provides some or all of the gas for the high pressure area of the pump from a source within the rocket engine or craft. This high pressure gas feeds the propellant into the combustion chamber. The gas source may be a pressurized gas container or a gas generator, generating gas from combustion of a fuel or other combustible.

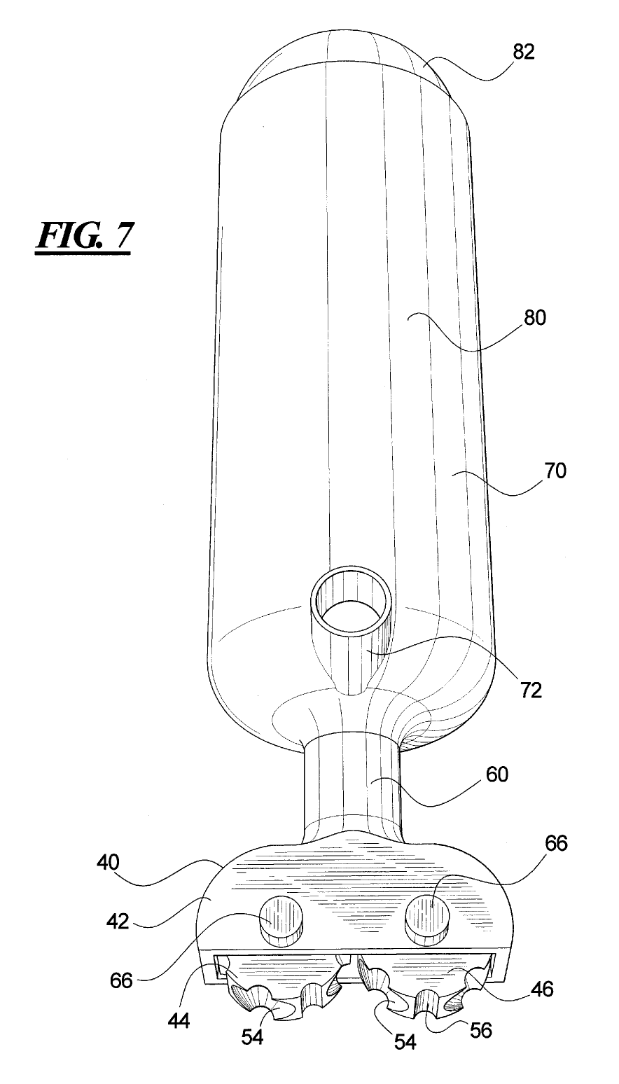

With reference to FIG. 4, a pump 40 is provided for receiving the elongated fuel structure and feeding the fuel into a combustion chamber (see FIG. 7). The pump 40 includes a housing 42 within which is mounted two pump wheels 44 and 46. The wheels 44 and 46 rotate on parallel axles 48 and 50 with their outer perimeters forming a nip 52 between which is fed the elongated fuel structure 20 of FIG. 1. The outer perimeters of the wheels 44 and 46 are provided with cut outs 54 and 56 that are shaped to accept the propellant elements 24 and coolant and gas generator elements 26, respectively, as the wheels 44 and 46 rotate on the axles 48 and 50. Preferably, a seal is provided by the wheels 44 and 46 bearing against the ribbon 22 and the propellant elements 24 and coolant and gas generator elements 26.

A high pressure area 58 is formed within the pump 40. The high pressure area 58 is sealed by the wheels 44 and 46 and by the housing 42 to prevent or reduce escape of gasses contained within the high pressure area 58. Seals are provided in the pump housing 42 to contain the high pressure gases. A pump exit tube or passage 60 extends from the high pressure area 58 of the pump 40 to a combustion chamber. The high pressure gases in the high pressure area 58 are ported to the combustion chamber through the pump exit tube 60.

At or near the region of close approach of the wheels 44 and 46 is provided coolant holding areas 62. The coolant holding areas 62 receive coolant, which is preferably a liquid such as water, when the coolant is ejected from the coolant cylinders 26. The coolant may be ejected into the interior space of the pump 40 and gravity or inertia moves the coolant to the coolant holding areas 62.

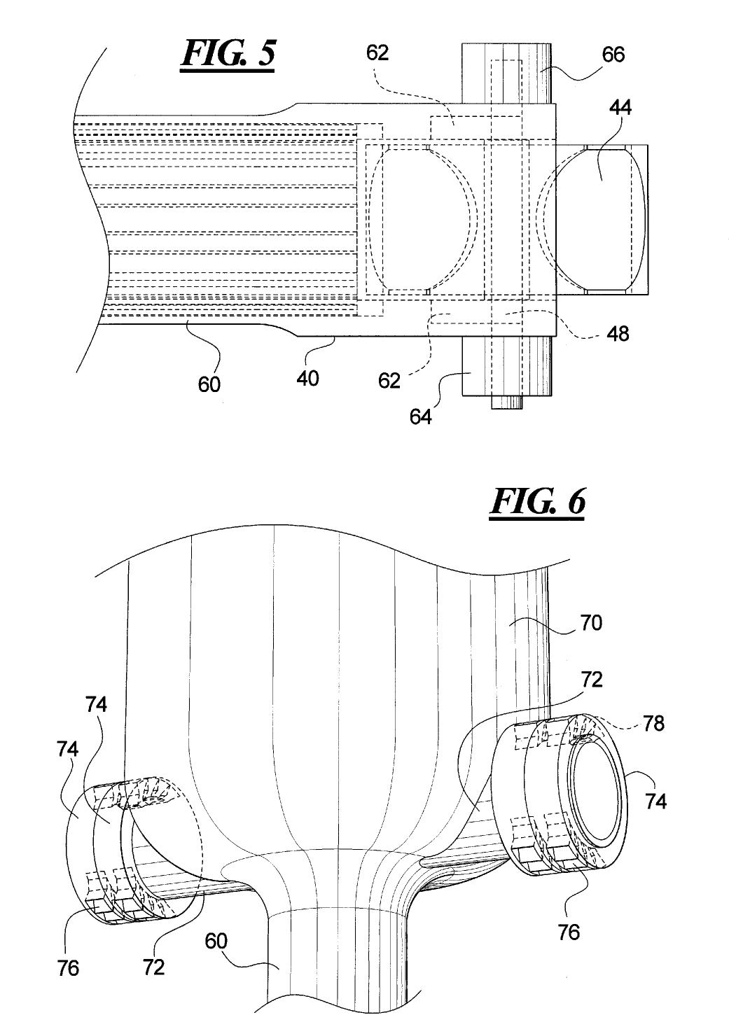

In FIG. 5, the pump 40 is shown in a view transverse to the axles 48 and 50. The shaped outer perimeter of the wheel 44 can be seen. The wheels 44 and 46 have a width approximately equal to the diameter of the propellant elements 24, which is also the approximate diameter of the interior of the pump exit tube 60. Two coolant holding areas 62 are provided, one on each side of the wheels 44 and 46. Units 64 and 66 are provided on the axles 48 and 50 of the wheels. The units 64 and 66 of one embodiment are bearing housings, or head elements, for the axles.

Referring to FIG. 6, the pump exit tube 60 is connected to a combustion chamber 70. The combustion chamber is generally cylindrical and axially aligned with the exit tube 60 and is of a greater diameter than the exit tube 60. The end of the combustion chamber 70 adjacent to the pump exit tube 60 is provided with nozzle supports 72 that extend in diametrically opposed directions from the combustion chamber 70. On the nozzle supports 72 are provided nozzle drums 74 that rotate on the supports. The supports 72 have openings that direct exhaust from the combustion chamber 70 to nozzles 76 in the drums 74. The exhaust escaping the nozzles 76 provide thrust for the rocket engine.

In a preferred embodiment, a main combustion chamber igniter is on the propellant ribbon. The start sequence includes the steps of: a) the ribbon is threaded through the wheels, and fed into the engine until the chamber igniter is inside the main chamber, b) a larger than normal gas generator is ignited inside the high pressure area, c) the pump quickly comes up to operating pressure, d) quickly, before the propellant moves too much the propellant is ignited in the chamber. In an alternative embodiment, the combustion chamber 70 has an igniter that ignites the propellant elements 24 that are within the chamber to start the rocket. A motor or other means may be provided to initially draw the elongated fuel structure into the pump 40 during start up. Igniters are well known and would be readily applied by those of skill in this art.

The nozzles 76 are movable by rotation of the drums 74 so that steering of the rocket can be accomplished by vectoring. Two drums 74 are provided on each support 72. The drums 74 may be independently movable to provide for better steering and control. The drums 74 include a second set of nozzles 78 which provide a different expansion rate than the nozzles 76. The drums 74 can be rotated into position to receive the exhaust from the openings in the nozzle supports 72 so that the second nozzles 78 are operable. The different expansion ratios of the nozzles enables the thrust characteristics of the nozzles to be changed quickly. Further sets of nozzles may be provided for other nozzle performance characteristics as well.

Turning now to FIG. 7, the pump 40 with the wheels 44 and 46 mounted therein is shown at one end of the pump exit tube 60 while the combustion chamber 70 with the nozzle supports 72 is at the other end of the pump exit tube 60. The pump housing 42 encloses a substantial portion of the wheels 44 and 46. The combustion chamber has a cylindrical outer wall 80 and a hemispherical end 82 to enclose an interior space within which combustion of the propellant takes place.

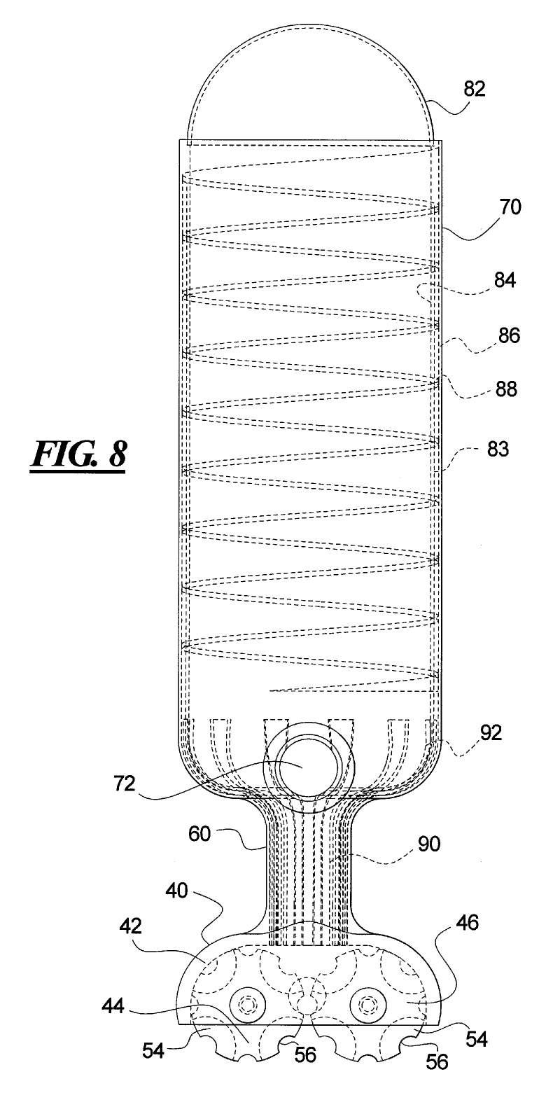

FIG. 8 illustrates interior structures of the rocket engine. The combustion chamber 70 is of a double wall construction having a helical space 83 defined between inner wall 84 and outer wall 86 by a helical divider 88. The pump exit tube 60 has channels 90 that extend longitudinally of the tube 60. The channels 90 also extend into the floor portion 92 of the combustion chamber 70. The channels 90 and helical space 83 provide space for coolant flow during operation of the rocket engine.

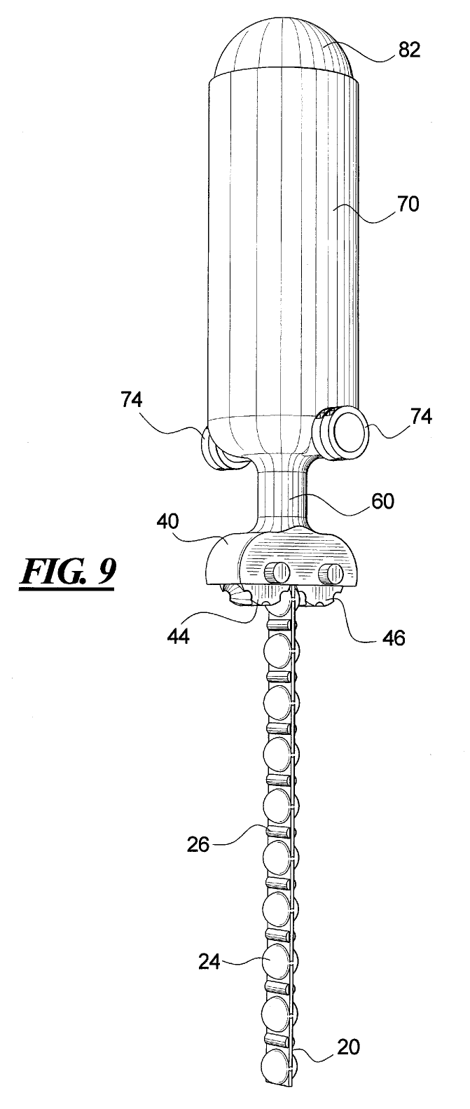

FIG. 9 shows the rocket engine with the elongated fuel structure or ribbon 20 being feed into the nip between the pump wheels 44 and 46, also referred to as injector wheels. The pump 40 feeds the propellant in the ribbon 20 through the pump exit tube 60 to the combustion chamber 70. Combusting fuel in the combustion chamber 70 produces exhaust that is directed by the nozzle drums 74 to provide thrust.

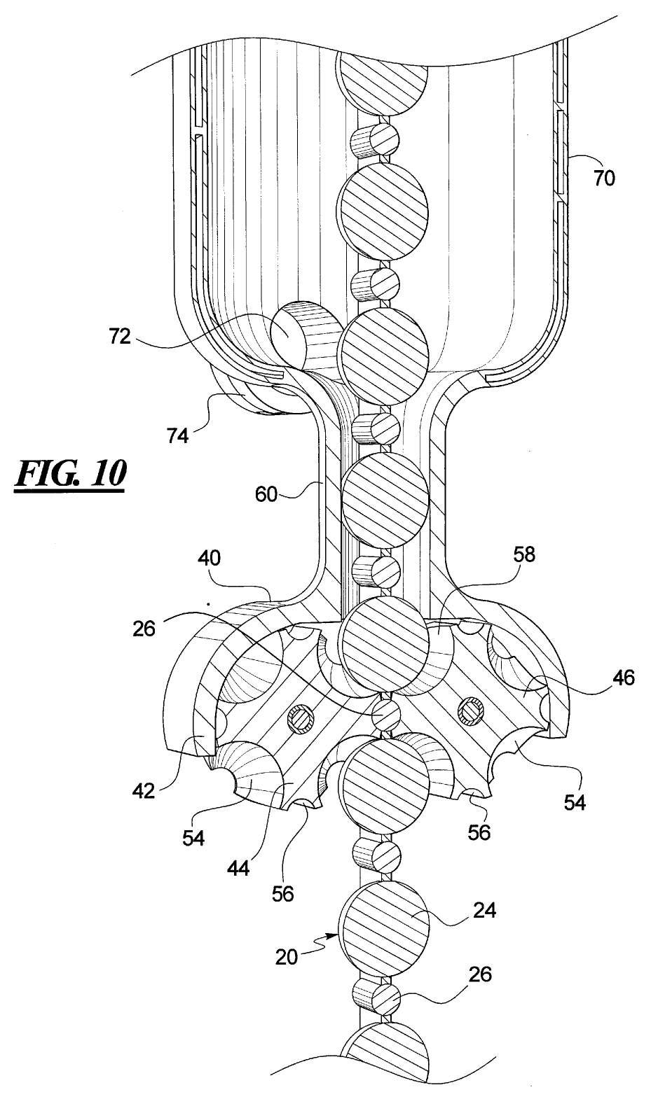

With reference to FIG. 10, the pump wheels 44 and 46 receive the elongate fuel structure 20 and the shaped recesses 56 engage the gas generator and coolant cylinder 26 that is disposed therebetween. The pressing force of the wheels 44 and 46 on the switch 38 (see FIG. 3) at or near to the gas generator and coolant cylinder 26 causes the gas generator 28 to activate, which will generate a volume of gasses that are captured in the high pressure area 61 of the pump 40. The pressure inside the high pressure area 61 increases, and acts on one or more propellant elements 24 that are within the pump exit tube 60. This causes the propellant element 24 to slide down the pump exit tube toward and into the combustion chamber 70. The ribbon structure 22 linking the propellant elements and gas generator and coolant elements 26 together draws in the elements that are external to the engine and moves the elements in series into the combustion chamber.

In order for the gases in the high pressure area 58 to push the propellant elements 24 along the pump exit tube 60, the pressure in the high pressure must be greater than that in the combustion chamber 70. The high pressure area 58 has a small volume compared to the substantially greater volume of the combustion chamber, so that a smaller volume of gasses generated by the gas generator is able to establish a high pressure within the high pressure area 58. The gasses within the high pressure area 58 are prevented from escaping by the elongated fuel structure 20 maintaining a seal between the wheels 44 and 46 and by seals in the pump 40. Except for any minor leakage, the primary escape path for the high pressure gas is through the pump exit tube as the gases push the propellant elements into the combustion chamber 70. The pressurizing gas flow is a subsonic flow, while the gases within the combustion chamber 70 exit the nozzles at supersonic speeds. The pressurizing gas of one embodiment is about one percent of the flow of the gasses leaving nozzles. The action of the high pressure pushing the propellant 24 along the tube 60 draws the ribbon through the wheels 44 and 46, causing them to turn, so that motor force is not required on the wheels during at least this stage of operation.

In FIG. 11, the elongated fuel structure 20 has been drawn further between the wheels 44 and 46 so that the shaped recess 54 in the wheels engages the propellant element 24. The engagement provides a seal preventing loss of the gases in the high pressure area 61. The gas generator ignites while in the high pressure area, or continues its gas generating activities while in this position, so that the high pressure is provided to push the propellant elements along the exit tube 60.

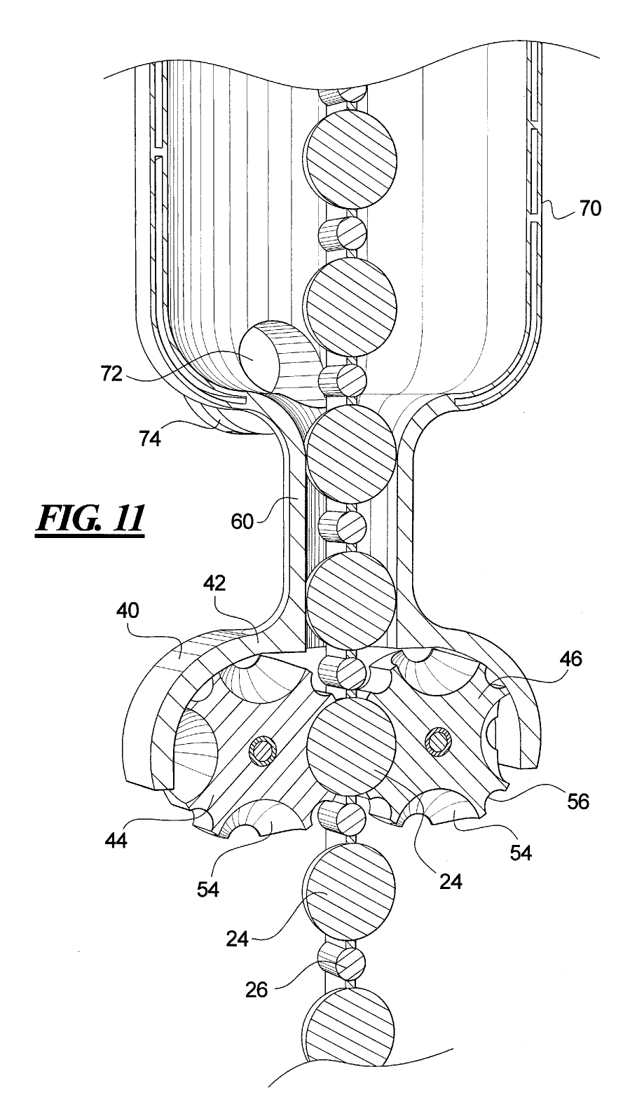

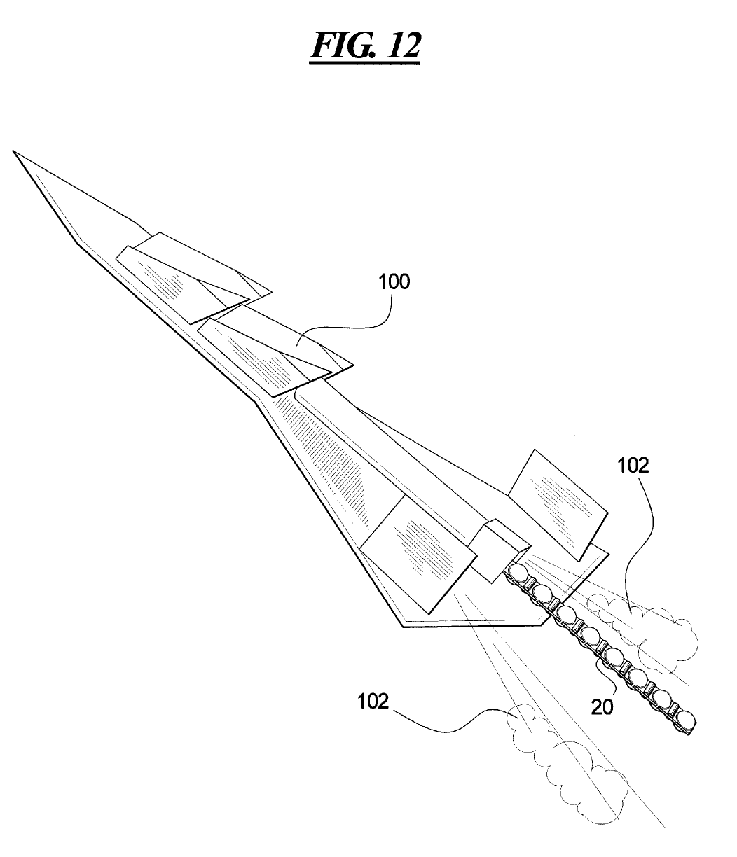

In FIG. 12, a craft, such as a passenger carrying craft or freight carrying craft is provided with the present rocket engine. Other uses include science and military and civilian applications. Two exhaust streams extend from nozzles of the rocket engine to provide thrust for atmospheric and super-atmospheric travel, while a strand of propellant elements, in the form of the elongated fuel structure 20 extends from the rear of the craft between the exhaust streams. In a preferred embodiment, the craft is a rocket plane for atmospheric travel so as to avoid ITAR restrictions on use. The preferred rocket plane operates at an altitude of approximately 75 km and achieves extreme hypersonic speeds. Preferred travel is at an approximate one half orbital distance between take off and destination. Take off can be from a runway or by vertical take off. Landing at the destination is at an aircraft runway.

The present rocket engine may be combined with other types of engines, such as jet engines or other types of engines, to provide controlled landing, for example.

The methods and the apparatus described herein allow for substantial improvements in the mass fraction of solid rocket engines, decouples the propulsion system design from the rest of the vehicle, while increasing safety and not greatly increasing the complexity of the rocket engine. The propellant can be stored indefinitely, and relatively inexpensive operations are possible.

Various different embodiments are possible within the principles of the present invention. The principles of the present invention provide a pump to take solid propellant, gas generators, and coolants from low pressure outside the engine to the high pressure inside the engine. The propellant is used as the pistons/turbine blades of the pump—virtually eliminating the normal problems of pump parts wearing out because the parts are by definition consumable. Furthermore, solid propellants do not require tanks to maintain shape at low pressures, so tank mass is completely eliminated. In addition, solids can be shaped to provide aerodynamic lift while outside the engine, increasing the percentage of thrust that can be used effectively. For example, the elongated fuel structure may be formed into an aerodynamic shape or enclosed within an aerodynamic housing or sheath.

Safety is also increased. First, because of the dramatic mass savings, high safety factors may be used in the engine designs. Instead of the normal 1.5 factor of safety, a factor of 3 is quite reasonable. Further, because the propellant is kept external to the engine at ambient pressure it is not a fire or explosion hazard. In addition, if the engine stalls the propellant, the elongated fuel structure, is immediately ejected from the rocket, either by residual pressure in the engine chamber or by drag forces on the propellant still external to the craft—there is nothing holding the fuel inside the engine other than the injector pressure of the high pressure area. Finally, in the extreme event that something unexpected does happen to the propellant, most of the propellant is hundreds of meters away from the aircraft, rather than closely coupled to the craft.

In the present rocket engine, extremely large mass fractions are possible. Using a safety factor of 3 times the yield strength in stainless steel, a design mass fraction of 50 was achieved—the rocket engine could carry 50 times its mass in propellant. Assuming an average Isp of 250 seconds, this would allow a maximum velocity change of 9580 m/s—allowing flight to any point on the globe, without staging.

In addition, the heat shield and aerodynamic qualities of the aircraft are decoupled from the propulsion system. When the propellant is used up or is ejected by stopping the engine, it needs no heat shield as no tank remains behind. The wings do not need to provide enough lift to lift the propellant load, because it can have a useful lift to drag ratio. Control surface authority is not impacted by the propellant loads because the propellant is never present during unpowered flight. During powered flight the propellant hangs from the engine and so does not affect aerodynamic controls.

An additional advantage of the engine is that if used for vertical takeoff, the engine does not need to lift most of the propellant until after ascending several hundred meters. This allows takeoff thrust-to-weight ratios to be lower than normal, and allows smaller engines to be used for larger than previously allowable payloads. For example: a vertical takeoff aircraft that has a thrust just equal to its gross lift off mass would not normally leave the ground—but if the propellant is in a ribbon, over half the mass is still on the ground as the aircraft passes 100 meters altitude, allowing the aircraft to accelerate before the propellant completely leaves the ground even though the thrust to weight ratio would not normally allow takeoff.

The present invention moves the propellant, coolant, and gas generators behind the engine in a ribbon the can be several hundred meters long. In this construction, the propellant is a solid propellant, such as that used in the space shuttle solid rocket boosters. It consists of small balls embedded in the long ribbon. Other types of propellant and other configurations are possible.

The coolant and gas generators are also embedded in cylinders in the ribbon. The gas generator is in the center of the cylinder, so that when it is fired it forces the coolant out of the cylinder and into a holding area inside the high pressure side of the pumping mechanism.

The pump mechanism consists of two wheels that pass the ribbon between them, the wheels having cut outs for the propellant, coolant, and gas generator shapes. This is the entrance into the high pressure side of the pump, which is pressurized to a higher pressure than the combustion chamber. It serves to limit the flow of pressurant gases leaving the pump, and to provide support against the pressure inside the pump. Past the wheels there is a volume to allow the pressurant gases to provide a somewhat stable operating pressure. The ribbon passes through this volume, and the gas generators are operating as the ribbon passes through this space. The ribbon then goes through a tube, where the spherical solid fuel acts like a piston and is forced into the combustion chamber by the pressurant gas.

The gas generators are activated by an electric firing mechanism, such as a thin nichrome wire. To provide the electrical power required to fire the gas generators, a battery at the end of propellant ribbon sends current up through wires embedded in the ribbon. As the electrically conductive pump wheels roll over special sections of the wire, they close circuits and activate the gas generator at the correct time.

The coolant is forced out of its carrying cylinder by the pressurant gases, and flows into a containment area in the high pressure section of the pump. (This also helps to cool the gas generator's gases, making engine design easier). From there, it flows through small channels that wind throughout the engine, combustion chamber, and nozzles—similar to the cooling channels in other rocket engines. Once it has passed through all the cooling channels, the coolant is dumped into the combustion chamber, and eventually leaves the rocket through the nozzle providing some amount of thrust.

The ribbon, cylinders, and propellant all enter the combustion chamber through the tube at the exit of the pumping mechanism, and are all burned and eventually flow out of the nozzle, producing thrust.

Thrust can be modulated by either controlling the electric current provided to the gas generators by the battery (not firing some gas generators to lower the pump pressure), or by opening a valve to bypass the piston and allow pressurant gases to flow directly into the combustion chamber.

In order to provide responsive thrust vectoring, fast thrust modulation, and efficient high expansion ratio nozzles for the upper atmosphere, a special nozzle system is employed. First, there is a tube coming out of each side of the engine which is closed at the end opposite the engine. There are two small slots cut facing rearward near the end of each tube for the exhaust to flow out. The slots cover a larger area than required by the nozzle so that the nozzle can be turned for thrust vectoring. An array of nozzles are cut into a ring that is either inside the tube, or outside the tube, depending on the details of how the tube is created. The nozzles all face the same direction, so that slight changes in angle will vector the rockets thrust, providing a controlling mechanism. A second array of nozzles is cut into the opposite side of the nozzle rings, providing a higher expansion ratio. To use these high expansion ratio nozzles, the nozzle ring is rotated 180 degrees to place this second set of nozzles in line with the slot cut into the carrying tube. The second set can be used as the previous set was for thrust vectoring. If desired, other sets of nozzles may be added as well—though each additional nozzle set added reduces the maximum angle that thrust can be vectored.

By having four independent nozzle rings, thrust can be quickly modulated and vectored in any direction. If all rings are rotated the same direction, the rocket is rolled. If both rings on each side are rotated in the same direction, but an opposing direction is used for each side, the rocket is rotated in pitch. If the rings on one side are rotated in opposite directions, a yawing moment is added. If the rings on both sides are rotated in opposite directions, the thrust can be decreased.

The preferred embodiment provides a method of increasing the pressure of propellant or other fluid, preferably for a rocket engine, where the propellant is used as either a piston or turbine blade. The method may provide that the propellant (piston/turbine blade) has a gas generator embedded in it to create the drive gas for the pump. Further, the method may provide that the propellant (piston/turbine blade) has a coolant fluid embedded in it to cool the engine and/or pump.

In one embodiment, the propellant is a solid in the shape of a ball, embedded into a ribbon of strong material. The material of which the ribbon is formed may be nylon. As a further development, cylinders are interspersed between the balls to contain a gas generator and engine coolant. In further detail, the gas generator can be disposed in the middle of the coolant, so that when fired it forces the coolant out of the cylinder. Alternatively, the cylinder may be crushed to force the coolant out of the cylinder. The ribbon can be passed between two wheels, with cut-outs for any propellant/coolant/gas generator shapes—the two wheels providing a pressure seal as the ribbon enters the pumping cavity. In yet another aspect, the ribbon the leaves the pumping cavity through a tube, with the propellant acting as a piston. The propellant/ribbon may be configured to provide some aerodynamic lift to the craft. In case of engine failure, the propellant may be forcefully ejected from the engine. The propellant of a preferred embodiment is a solid. Alternatively, the propellant is a liquid inside a small sphere. The propellant may be a cryogenic solid. The invention may provide that the ribbon contains two conducting wires, allowing a battery at the end of the ribbon to activate the gas generators when each circuit is closed in turn by the sealing wheels.

According to one embodiment of the rocket engine, vectoring of the rocket thrust is accomplished using four or more rings with nozzle arrays cut into them. The nozzles can be turned small angles for thrust vectoring, or turned large angles to switch expansion ratios.

The elongated fuel structure or ribbon is external to the aircraft. The exhaust forms two streams to each side of the ribbon. The ribbon has some rigidity in the proper direction to prevent it from “whipping” into the nearby streams because of its flat shape, and because the exhaust streams leave the rocket at a small angle. Although in some embodiments the fuel structure may have a covering, that is not necessary in every embodiment and the covering adds extra mass to the aircraft that it would need to take all the way to its destination. In general, the preference is to throw as much stuff overboard as possible without endangering someone on the ground (as things thrown overboard should be vaporized first).

Another reason to not have an external structure around the ribbon is to simplify ground operations and takeoff. The aircraft should be able to use normal runways with either a “skid” for the ribbon to go over placed down the center of the runway, or a reel that reels out the ribbon as the vehicle takes off. The reel is preferable, because it allows a higher takeoff acceleration, but that is probably a more difficult modification to the airport.

The exhaust from the thrust nozzle is kept from the fuel structure or ribbon portion at the back of the rocket by the ribbon being somewhat rigid in that plane (the flat plane of the ribbon keeps it from moving towards the exhaust). The exhaust leaves the rocket nozzle at a small angle away from the ribbon. This decreases the thrust somewhat but not by enough to cause serious issues, because the thrust is proportional to the cosine of the angle, while the exhaust clearance is proportional to the sine. For example, if the nozzle exhaust leaves the rocket nozzle 20 degrees away from the ribbon line, thrust is only decreased by 6%, while for every meter the exhaust travels it gets 0.34 meters away. (Proof: 0.96̂2+0.34̂2=1) In the atmosphere, this should be sufficient to keep the exhaust from interacting too much with the ribbon.

Once the atmospheric pressure starts to drop, though, the exhaust will eventually envelop the ribbon. Because of the lower pressure, however, the exhaust will have cooled (and in any case, a lower pressure gas cannot conduct much heat energy into a solid)—and the ribbon will have a thin ablative covering (for example, a few microns of nylon plastic or other material) that will keep it from burning. However, it is very hard to get this fuel to burn at one atmosphere, let alone less than one atmosphere—so that the fuel really needs to be inside the rocket's combustion chamber, for example at above 10 atmospheres or so, in order for it to burn.

The plastic coating is highly desirable for other reasons as well—it weatherproofs the propellant for more resilient storage and operations. It also makes ribbon production easier.

Also, at extreme altitude the injector gases (which are pretty cold after leaking out through the injector wheels) form a barrier between the ribbon and the exhaust plumes.

The ribbon extends hundreds of meters behind the rocket, which results in the ribbon experiencing drag. However, the present rocket provides a small frontal area, since the propellant is behind the rocket and not contained in a tank that is a structural part of the craft or attached to the craft. To a certain extent, to launch a payload into a near-orbital flight path requires a certain volume of propellant. In a standard rocket, height to width ratios are limited by structural integrity constraints. In large rockets (such as the Saturn V rocket), these constraints are relaxed and the designs are extremely tall: the Saturn V had minuscule air drag losses. As rockets scale down, even 10:1 gets hard to achieve because the propellant storage tanks buckle—they are extremely light-weight designs.

The elongated fuel structure or ribbon avoids this by turning the problem upside down—a stretched ribbon has no buckling forces, so it can be virtually any length. This permits the use of a smaller frontal area for a given volume with a long ribbon—and that decreases aerodynamic drag. The shape is not ideal, but not too bad, and can be tailored to a certain extant to minimize drag.

If the ribbon breaks, then the aircraft's acceleration would jump up, and the pilot would notice and throttle back immediately and after assessing the situation the pilot would probably abort to an alternate landing field. The ribbon breaking would no cause damage to the aircraft, but would obviously shorten the vehicle's maximum range.

The most dangerous situation for the pilot/vehicle would probably be the engine going out and the ribbon staying attached. It is unlikely that the vehicle would be landable in that state, so the recommended procedure would be to immediately pull a high-G maneuver which would force the ribbon from the engine, or cause the ribbon to snap. Either way, the aircraft would be much safer to land. Alternately, a ribbon severing or ribbon releasing mechanism may be provided to ensure that the elongated fuel structure is detached from the craft in the event of the engine being extinguished.

The ribbon and coolant cylinders are burned in the combustion chamber and any remains leaves though the nozzle. Or more exactly, the coolant cylinders ablate more than they burn—though nylon would at least provide some extra energy to the reaction. As the ribbon and attached coolant cylinders go into the combustion chamber, they remain attached as they quickly melt and then vaporize. Essentially, the non-propellant mass gets to the top of the combustion chamber before it loses all structural integrity, and by the time it gets back to the bottom the hot combustions gases from the propellant have vaporized it, or at least make the ribbon so flimsy that it will easily pass through the nozzle. Previous testing of hybrids has shown that very large sections of rubber can be thrown through a properly designed nozzle—sections much larger than the nozzle! The cylinders and ribbon material do not add much to thrust (in fact, it is predicted to decrease thrust by a tiny amount)—the important aspect is that their mass is removed, and removed in a way that does not endanger anyone on the ground.

Thrust is modulated by controlling the electrical current to the gas generator. The thrust change is done by controlling the amount of gas generated by the gas generator, and therefore the pressure in the injector. A higher pressure in the injector than in the chamber will accelerate the propellant into the chamber (more propellant provides more thrust), while a lower pressure will decelerate the rate at which the propellant is provided to the combustion chamber (less propellant results in less thrust). If no gas generators are firing the pressure in the injector will fall below the chamber pressure, because the injector gases leak out at the pump exit tube and at the back of the injector—the ribbon does not perfectly seal the injector. A higher degree of sealing at the pump wheels would require less injector gas to be required and so the present invention contemplates incorporating seal configurations and materials that provide improved sealing. A challenge for the seal is to accommodate hot or at least warm gases. Embodiments with less effective seals at the pump wheels provide leaked injector gas which forms a barrier between the exhaust plumes and the ribbon at high altitude.

A design detail—the easiest way to make the gas generators able to be modulated is to have multiple generators in a line in the same cylinder. For example, three gas generators are provided in a row (with the coolant only on the outer most sides) there is the possibility of only firing the outer two gas generators. This would generate less gas than firing all three, but would still push all the coolant out—and the remaining gas generator would be burnt inside the combustion chamber. This can be simply extended to any number of generators—though this may not be required for typical usage.

A further design detail—the gas generators are very simple, essentially just a low temperature burning solid (like gunpowder) in close proximity to a thin wire used to ignite it.

The injector volume is at higher pressure than the chamber, and so the propellant is pushed into the chamber by the pressure difference. The pressure in the combustion chamber during normal operation does not force the ribbon out the back of the injector instead forward into the chamber. This is because the wheels at the bottom of the injector area support the pressure load, and the propellant spheres do not “see” the injector pressure until they are inside the injector. Essentially, the injector functions in much the same way as a gear pump.

The present rocket engine is a continuous thrust engine as opposed to a pulsed engine. Engine mass is highly correlated to the amount of propellant it must contain, so propellant is to flow into the engine, burn, and flow out the nozzles as quickly as possible.

The coolant itself is pooled up and then travels throughout the engine (cooling it) and turns to steam and then is dumped into the chamber. (It can be dumped into the chamber because it is coming from the injector, which is at a higher pressure.)

If the engine where to shut off while some of the elongated fuel structure is still hanging from the engine, it would dramatically affect the aerodynamic control—the craft would quickly become virtually uncontrollable, and which is a serious situation that would require immediate action to correct. The ribbon will not stay attached to the engine unless it is running, as it is only held in against the force of the combustion chamber's pressure (or, if the engine has completely gone out, the ribbon's drag) by the injector pressure. In the case of an injector failure, the combustion chamber's pressure will eject the ribbon. In the case of an engine losing pressure (a flame-out of some kind), the injector pressure goes away in seconds (as no new gas generators are being fed into it once the combustion chamber is filled), and the aerodynamic drag on the ribbon pulls it out of the injector. In the case of catastrophic engine failure, the ribbon is not held to the aircraft in any way other than the engine injector—so the ribbon falls away from the aircraft.

As long as the engine is running, aerodynamic controls are not used for maneuvering—thrust vectoring is used instead, so the inherent aerodynamic instability doesn't matter. In fact, as long as there is thrust, the vehicle is aerodynamically stable. One conceptualization is that of a kite with a long tail. In the aircraft, RCS thrusters are also used to maneuver after main engine cut off—these could also be used to provide a force to pull the ribbon from the aircraft in an emergency.

The gas from the gas generator becomes the “atmosphere” inside the injector. Most of that gas will eventually flow through the tube into the combustion chamber, pushing the propellant along in front of it. From there, it mixes with the combustion gases and flows out through the nozzles. A small amount of the pressurant gas leaks around the wheels and flows out the back of the injector. Since this is a very small amount of gas compared to the combustion gases, the effect on performance is very small—but at high altitudes, when the exhaust plume completely envelops the vehicle, this small amount of leakage gas is nice to have around because it is a lot cooler than the main combustion flow.

The coolant is initially pushed from the cylinders “near/above” the coolant holding area by the gas generators. Essentially, the coolant will be sprayed out of the cylinders, and collect in a pool in the holding area as gravity/thrust forces pull it into the collection area. When the engine is started, above is determined by gravity. Once the engine is running, above is determined by thrust.

The coolant of a preferred embodiment is a liquid, which takes advantage of the energy absorption of the liquid-gas transition in the cooling system, and in one embodiment is water. It is unnecessary to take special precautions to separate the water from the gas generator gas, because gravity or thrust makes the coolant fall down into the collection area. Some coolant will most likely be vaporized by the initially hot gas generator gas, but this has little or no negative impact in engine performance, the vapor is considered part of the gas generator gas, which should be relatively cool anyway.

The combustion chamber, nozzle supports, pump exit tube and other portions of the device include an arrangement of coolant passages, which extend through much of the structure except the injector which is not very hot.

Thus, there is shown and described a rocket engine for manned or unmanned space flight and atmospheric flight uses an elongated fuel structure that is external to the combustion chamber and that is fed into the combustion chamber during operation of the rocket. The elongated fuel structure includes propellant elements and may include coolant elements and gas generating elements as well. The elongated fuel structure of one embodiment is a ribbon. The ribbon is fed between two opposed wheels of the fuel pump, which seal the engine from escaping gases while permitting the elongated fuel structure to be drawn into the engine. The opposed wheels may serve to activate the gas generating elements, so that gas pressure generated thereby drives the propellant elements into the combustion chamber of the rocket engine. The activation of the gas generating elements also provides coolant to the engine from the coolant elements, in one embodiment.

### Second Embodiment

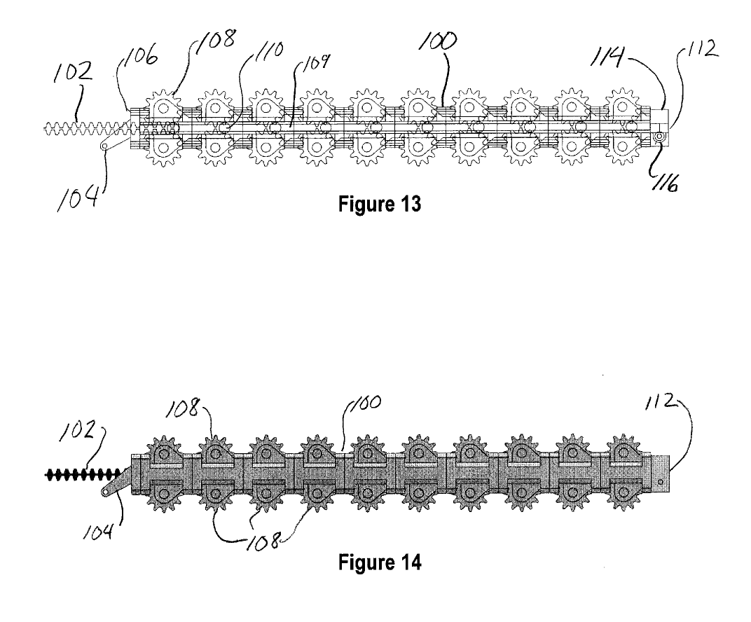

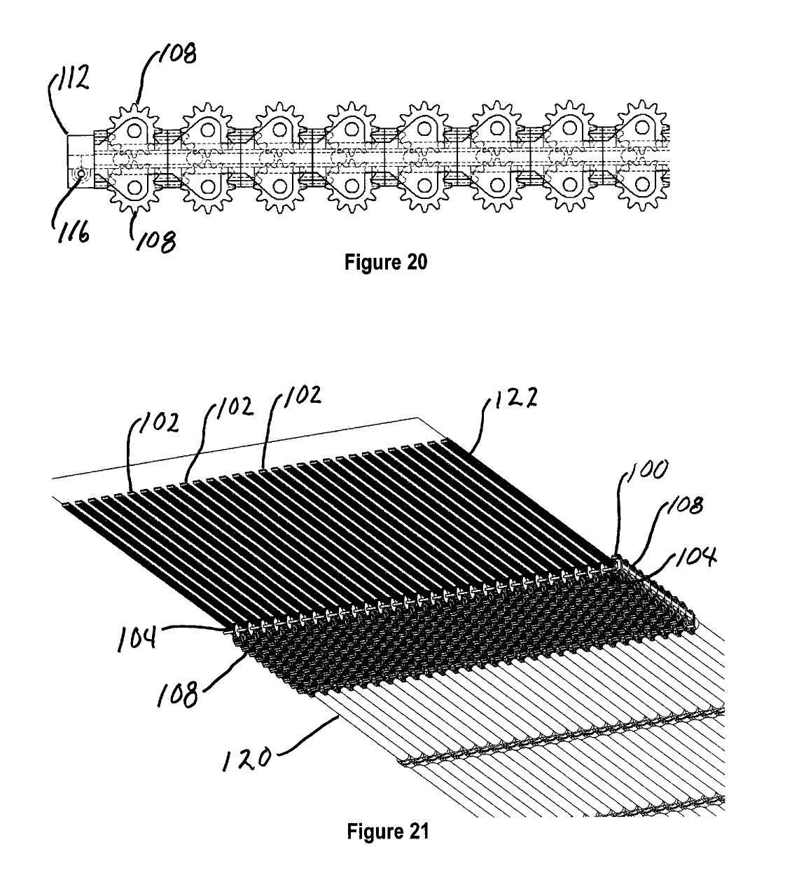

Another embodiment of the present rocket engine and fuel ribbon is shown in FIGS. 13-21. The primary change from the first embodiment to the second embodiment is that the propellant ribbon works better if:

1) If instead of having spheres spaced out, the ribbon looks like the “rack” in a rack and pinion mechanism. This is easier to manufacture, and burns more rapidly. It also spreads out the stresses better, and prevents the injector drive wheels from jamming.

2) If instead of having gas generators in the ribbon, main combustion chamber gasses are used in a multistage injector. This is driven primarily because the previously used gas generator pressures got so high during design that staging the injector became essential—and once the injector is staged, it becomes easier to just use the main chamber gasses. The main chamber gasses can still be cooler than what is exhausted through the main nozzle, all that need be done is make the first layer of the fuel elements burned be a lower temperature. Because the required pressures for a given injector force are lowered, the length of the ribbon can be increased. This greatly benefits the aircraft's performance (there is very little cost for a longer ribbon compared to altering the aircraft). Currently the preferred ribbons are 1-2 km long.

3) Because the gas generators of the first embodiment are eliminated in the second embodiment, the coolant must be extracted from the fuel ribbon in a different way. According to one embodiment, a spinning saw mechanism is provided in the engine at a location so that the saw can cut open the ribbon's coolant containers, once the coolant containers are inside the combustion chamber. This is less expensive for manufacturing of the fuel ribbon as well, since the fuel ribbon has no active parts. For example, the igniters for the pressurant gas generators of the first embodiment are eliminated.

4) Because the ribbon of the second embodiment is not an efficient shape for a pressure vessel (in the first embodiment it includes spheres, and in the second embodiment it is a wide and thin ribbon), the ribbon is cut up before entering the injectors. For example, a 1 meter wide ribbon 1 cm thick would be cut into 50 separate 2 cm wide ribbons, each 1 cm thick, and each smaller ribbon is fed into it's own injector. This leads to far more efficient and lightweight designs. Cutting and separating the ribbons can be very simple, because there is no stress during the flight that would pull the ribbons apart—so almost pre-cut channels can be provided.

5) Now that the ribbon is cut into a smaller ribbon, and each smaller ribbon has it's own injector and combustion chamber, scaling up the design becomes very simple—for instance a wider ribbon is used, and more injectors and chambers are added. This allows the base design to be quickly scaled.

6) In addition, since the ribbon of the second embodiment is more truly a ribbon, it's aerodynamic characteristics are better—but so are the aerodynamic characteristics of its associated injectors and chambers. Because of that, a “hot wing” (similar to a more conventional “wet wing”) design may be used—basically much of the wing structure and support is provided by the engine chambers. This makes the overall aircraft lighter and stiffer, making design easier. This leads towards swept forward, or very wide wings.

All of the benefits of the first embodiment still apply to the second embodiment.

As the propellant load and thus the required injector pressure increases, a lower mechanical stress method of using pressurized gas to force the propellant into the chamber becomes desirable. In addition, the maximum loading speed of the propellant becomes quickly limited by the burn rate of the injector gas generators. Both these limitations can be eliminated by using a multiple stage injector, driven by the main chamber gas. Each stage only provides a fraction of the driving force, greatly decreasing the pressure required. The stages exhaust into low pressure nozzles, so the chamber pressure is sufficient to drive each stage. While more gas is required, the gas can still be sent through low pressure nozzles after exiting each stage so the performance loss is quite small.

The first embodiment design has a rather low volumetric efficiency—the spheres are too widely separated for a mass efficient design. In addition, controlling the exact moment of ignition of the spheres has encountered problems. These problems can be solved by going to a rack and pinion design, where the rack is the propellant. To fix the timing and location of propellant ignition, a rotating cutter blade is used to slice through the protective coating around the propellant so as to expose the propellant directly to the hot chamber gases. In addition to making the combustion more consistent, this blade also cuts open the coolant reservoirs allowing coolant to be collected and used for cooling the engine.

Additionally, by using multiple, smaller ribbons placed side by side the total engine mass can be minimized. The smaller ribbons burn much faster, making the overall engine much smaller. The multiple, smaller engines run hotter—but once working, any number of engines can be used for any multiple of thrust. This allows for easy scaling of the engine design to practically any size vehicle. The smaller side-by-side ribbons also make operations easier, because the ribbon is thin and flat. The ribbon can be more easily loaded onto spools, etc. for shipping.

When designing a vehicle powered by this engine, advantage can be taken of the inherent strength of the engine's chamber by using swept forward or stubby wings. Swept forward wings require a higher stress design to prevent buckling, but allow the rocket exhaust to be directed very nearly straight aft. Stubby wings merely take advantage of the engines long rectangular shape and require the exhaust to exit at an angle to the vehicle's line of flight, but is much simpler to design.

The operation of the second embodiment is as follows:

A spool holding the wide ribbon (comprised of multiple smaller ribbons joined by a thin plastic covering) is shipped to the airport using standard shipping containers. The vehicle goes to the end of the runway. A truck carrying the spool in a standard container drives to the end of the runway, and parks perpendicular to it. A door is opened in the container, and the ribbon is pulled over to the vehicle and threaded into the engine. At this point it is of note that most of the mass is supported by the spool, not the vehicle. The spool can also have a separate engine (of normal design) to control the rotational speed of the spool, alleviating the vehicle's engine from the requirement to accelerate the full mass of the propellant. The vehicle can then start it's engine, accelerate down the runway and take off in a very short distance because the wings need only lift the vehicle, not the propellant load.

As the propellant ribbon flows into the engine's injector, the thin plastic covering that joins the smaller ribbons into a single large ribbon is cut by rotating or fixed blades. This frees each of the smaller ribbons to flow into its respective engine injector's first stage. In the injector, the ribbon (acting as a double sided rack) goes between two pinion gears. On the far side of the pinion gears, high pressure combustion chamber gas is introduced. The pressure makes the propellant push back against the gears, but the gears are also pushed by the gases in the opposite direction due to the tops of the gears being exposed to a lower pressure area. In addition to this, a little forward of the pinion gears the ribbon is also exposed to the low pressure area. This exerts a net forward force on the ribbon, forcing it into the second stage of the injector. The second stage of the injector works identically to the first, pushing the ribbon into further stages until the last stage pushes the ribbon into the chamber. As the ribbon enters the chamber, a rotating or fixed blade is used to cut open the protective coating of the propellant ribbon, exposing the propellant to hot combustion gases and igniting it. At the same time, the blade also cuts open the coolant reservoirs in the propellant ribbon. The coolant is then collected and sent through the engine, cooling it. Once the coolant has gone through the cooling channels, it can be dumped through a low pressure nozzle providing some amount of thrust.

As a further refinement, the propellant can be composed of two different layers, an outermost layer that burns at a lower temperature than an inner layer. The outer layer will burn closer to the injectors, allowing the injector gases to be cooler and thus the injector design to be simpler. The inner layer burns hotter, giving the engine more energy and efficiency from the gas flowing out the main nozzle. By controlling the flow of gases from the chamber into the injector, the engine can be throttled.

FIG. 13 shows a single injector 100 of a rocket engine of the second embodiment. Elements in the drawing are described from left to right.

A propellant ribbon 102 of the second embodiment is shaped like a rack gear from a rack and pinion gear pair, or more accurately like back-to-back rack gears having gear teeth disposed on both sides extending in opposite directions from the two opposed surfaces. The shape of the propellant ribbon is referred to here as a double rack. In one embodiment, the propellant ribbon 102 is 2 cm wide by 1 cm tall. The illustrated ribbon structure is one of many such ribbons, where multiple such ribbons are joined side-by-side to one another by an easily cut thin plastic sheet.

A ribbon cutter 104 that separates the multiple side-by-side ribbons 102 from each other by cutting the thin plastic sheet that joins the ribbons to one another is shown. The ribbon cutter 104 is mounted at the fuel intake end 106 of the injector 100 of the rocket engine. The illustrated ribbon cutter 104 holds a blade, such as a circular blade that is mounted at the opening in the free end of the ribbon cutter. The blade is not shown in this view but is shown in FIG. 21.

Pinion gears 108 for a ten stage injector are shown. The pinion gears 108 are provided in pairs, each pair of pinion gears 108 is a stage of the injector 100, and ten such pairs are provided. Each pair of pinion gears 108 is mounted spaced apart so that the double rack of the propellant ribbon 102 may pass between the gears 108 with the teeth of the propellant ribbon 102 meshed with the teeth of the pairs of pinion gears 108. A seal is formed by the meshed teeth of the ribbon and gears. The pairs of pinion gears 108 are arranged along an injector shaft or fuel passage 109 that extends from the fuel intake end 106 to the fuel outlet end 112. In operation, the injector 100 is like a gear pump; gasses from the chamber flow (from right to left) through a shaft parallel to the injection shaft 109. The gases flow through round holes 110 (in the middle of each pair of top and bottom gears 108). The gases apply pressure to the propellant ribbon 102 in a forward direction and in a backward direction (these forces cancel one another), and also provide a rotational force to the pinion gears 108. The sum of these forces pushes the propellant ribbon 102 into the combustion chamber. The combustion chamber is at the outlet end 112 of the injector 100. The gases flow out of the engine both through the pinion gear's teeth and through a port downstream (to the right) of the pinion gears 108. This is a variation of the gear pump from the first embodiment. The primary difference is that this gear pump can be staged, so the pump gas does not need to be at a higher pressure than the combustion chamber.

After the ten stages, or pairs of pinion gears 108, of the illustrated injector 100, there is provided an adapter and cutter component 114. In addition to connecting the injector 100 to the combustion chamber (and allowing chamber gases to flow into the injector to provide pumping power), the adapter 114 has a small blade 116 embedded in the bottom of the runway or fuel passage 109. The blade 116 does two things: first, it cuts open the coolant spaces or chambers in the propellant ribbon 102, allowing the coolant to spray or flow into the area around the blade 116 where it is collected and used for cooling the engine. Second, the blade 116 cuts the ablative protective covering on the propellant ribbon 102. This makes the propellant flammable in the chamber, but not flammable while streaming behind the rocket vehicle.

The injector 100 is shown as having ten stages, although more or fewer stages may be provided. The rocket lift engine has only one rocket stage in this embodiment, but the injector 100 is provided in ten sections or stages. Each section provides 1/10th of the force needed to lift the ribbon 102 into the engine. Each section of the injector, each pair of gears, is referred to as a stage.

The multiple stage injector is desirable is because of the weight of the propellant 102. If testing is carried out on the ground so that the propellant is supported by rollers, for example, the only force to be overcome to inject the propellant into the engine is the engine's chamber pressure. To do that, only a slightly higher pressure than the engine itself is needed, for example, to overcome friction and other inefficiencies. As an example, a one meter wide, 1 cm thick ribbon going into a 40 atmosphere chamber needs about 4.5 tons of force applied, so a 45 atmosphere injection would work.

However, the propellant at launch weighs 30-60 tons (depending on the mass fraction needed. So, the vast majority of the force required is pulling the propellant up, not forcing it into the chamber. As an example, the first embodiment would require 600 atmospheres of injector pressure to lift 60 tons. By separating the injector into stages, each stage only has to apply 3-6 tons. As an example, to apply 3 tons would require an injector pressure of 30 atmospheres, less than the chamber pressure of 40 atmospheres. This way, not only can a decrease in the stress placed on engine parts be realized, but there is no longer a need for separate gas generators in the ribbon. Instead of using gas generators, the second embodiment taps some of the combustion gases from the combustion chamber.

FIG. 14 is a side view of the second embodiment of the injector 100 for a solid fuel rocket engine. The propellant ribbon 102 first encounters the cutter 104 and then is taken between ten pairs of pinion gears 108 so as to be carried along the interior of the injector and brought out the end 112 of the injector. The fuel leaving the end 112 of the injector is fed into the combustion chamber, similar to the combustion chamber of the first embodiment. Exhaust from the burning fuel is directed out of rearwardly directed nozzles to provide thrust, propelling the rocket. As noted with respect to the first embodiment, the nozzles may be controlled to direct the thrust as desired. Control of the thrust may be implemented by changing the nozzle configuration, as noted above, or by regulating movement of the fuel ribbon into the combustion chamber. Operation of the rocket engine may be halted by ceasing input of the fuel ribbon into the combustion chamber, such as by cutting the fuel ribbon that is being fed into the injector.

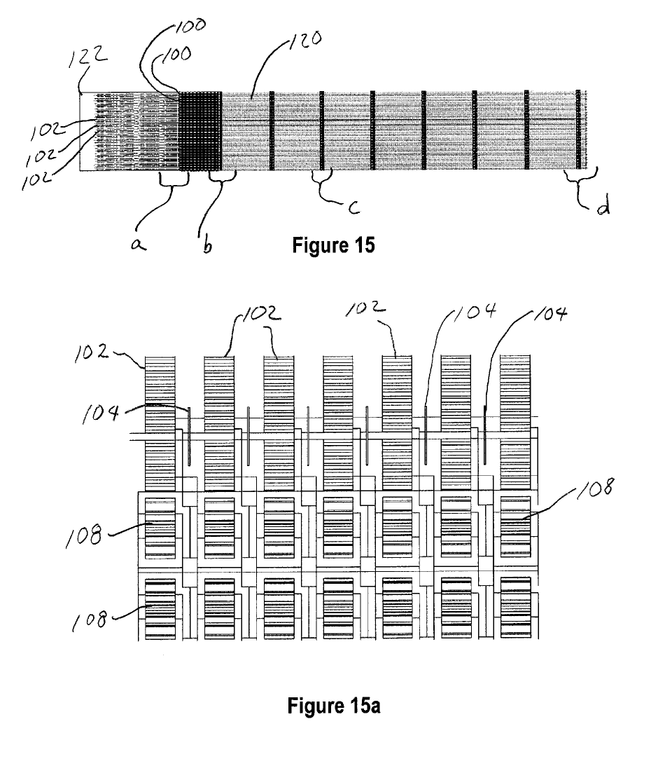

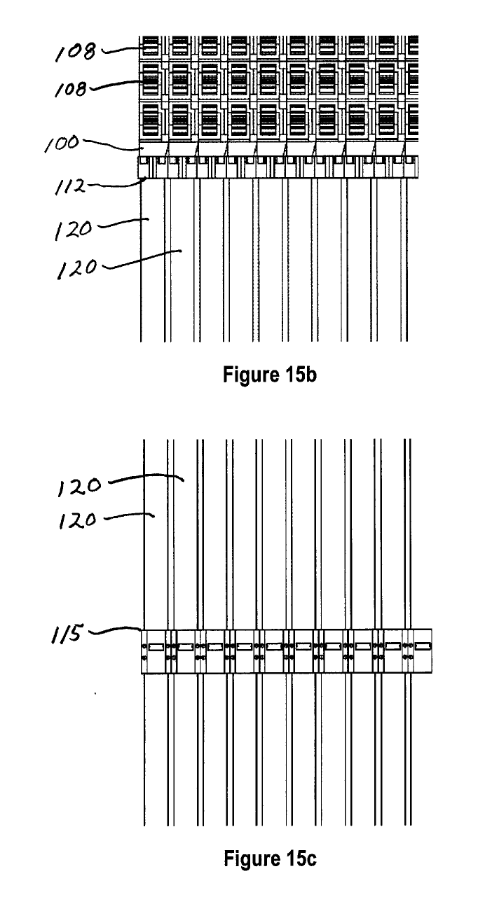

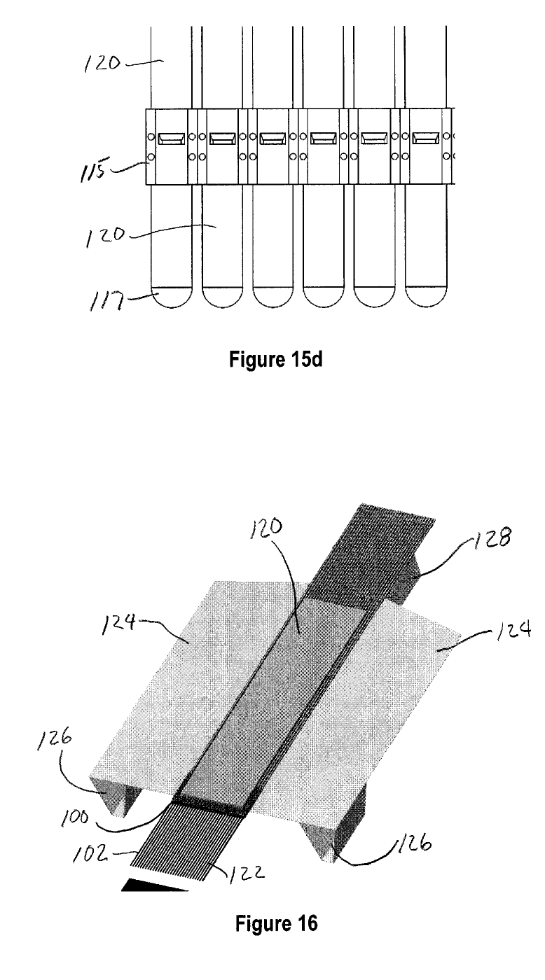

Multiple injectors 100 of the second embodiment may be arranged side-by-side to scale up the thrust achieved by the rocket. FIG. 15 is a view of the way the injectors 100 and engines 120 are assembled side-by-side, allowing easy scaling of the design. All of the engines 120 are identical. Each cuts a separate small ribbon 102 out of the larger, wide ribbon 122 that is made up of the side-by-side ribbons 102, and operates independently on it. The multiple injectors 100 may each feed their own separate combustion chamber or the separated parts of the fuel ribbon may be fed into a common combustion chamber. FIG. 15 shows 30 injectors arranged side-by-side in one example. FIG. 15 is marked with regions a, b, c and d, corresponding to the enlarged view FIGS. 15a, 15b, 15c and 15d.

As shown in the enlarged view of FIG. 15a, which corresponds to region a of FIG. 15, the side-by-side ribbons 102 form a wide, flat ribbon body 122. The ribbons 102 are cut apart from one another by the cutters 104. After being cut, the ribbons pass between the pairs of pinion gears 108. Only seven of the thirty ribbons 102 and injectors 100 are visible in this enlarged view.

FIG. 15b shows the outlet end 112 of the injectors 100 at region b of FIG. 15. At the outlet end 112 is connected the combustion chambers 120.

FIG. 15c shows the elongated combustion chambers 120 arranged side-by-side of region c. A support bracket 115 extends between the combustion chambers for support, and provides outlet for the exhaust gases. Seven such brackets 115 are provided in the example.

FIG. 15d shows the last bracket 115 and the ends 117 of the combustion chambers 120 of region d.

In FIG. 16 is a view of the second embodiment of the rocket plane 130. The rocket plane 130 is supplied with fuel via the solid fuel ribbon 122 formed of the side-by-side arrangement of ribbons 102. The ribbon 122 is drawn into the injectors 100 which in turn feeds the fuel into the engine chamber 120. From the engine chamber 120 extends two short wings 124. Thrust nozzles 126 hang below the wings 124. A passenger and cargo compartment 128 is provided between the wings 124. The most important part of the rocket plane configuration is that most of the load is carried by the engine chamber 120, because the engine chamber has high intrinsic strength requirements. This favors designs that use either swept forward wings or simply long and thin wings along the fuselage rather than more standard long and thin wings at right angles to the fuselage.

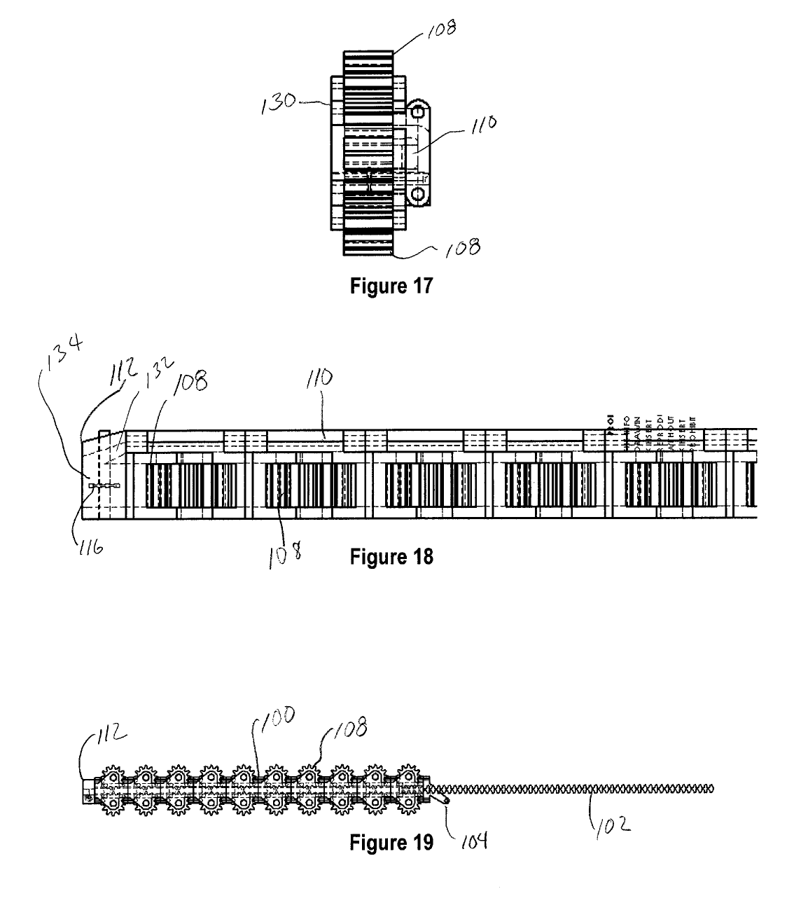

FIGS. 17, 18, 19 and 20 show various views of the injector 100 of the second embodiment, showing the passage for the propellant gases and various other parts in greater detail. FIG. 17 is an end view of the injector 100 with the two end-most pinion gears 108 mounted for rotation in an injector housing 130. In FIG. 18 the cutter 116 is shown in a position to cut the fuel ribbon 102. A side passageway 132 joins the main passageway 134 at the fuel outlet end 112.

FIG. 21 is a view of the small ribbons 102 joined by a thin plastic sheet to form the wide ribbon 122 and the cutters 104 that slice the wide ribbon 122 into the separate small ribbons 102 for each injector 100. The thin plastic sheet is preferably formed over the fuel elements that are arranged at regular spacing along the ribbon.

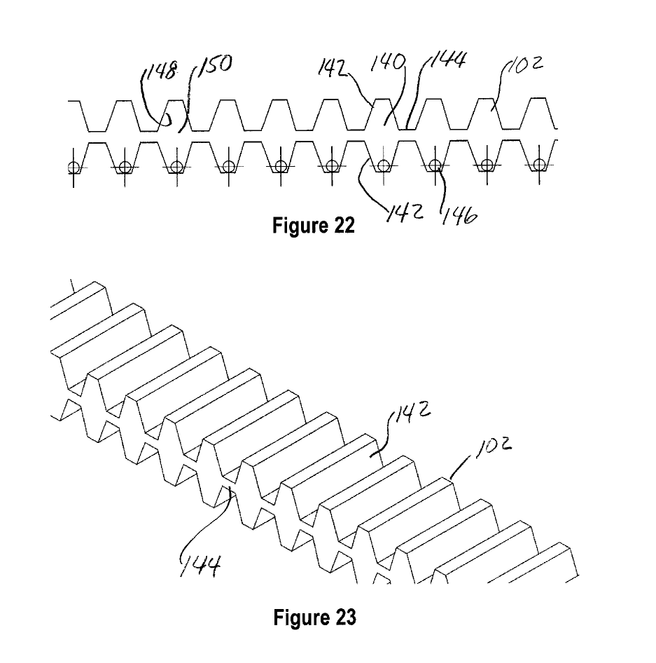

In FIG. 22, the ribbon 102 is shown in side cross section. The ribbon 102 is made up of solid fuel elements 140 that have a shape to form two oppositely directed teeth 142 of the double rack. The solid fuel elements 140 are joined to one another by thin flexible sections 144, which may be formed of the plastic material that joins the multiple ribbons into a wide ribbon body 122. Within the lower tooth 142 is a coolant container 146 that contains water or another coolant that is used during the rocket operation to reduce heating. The coolant containers 146 of one embodiment are cylinders, or may be of other shapes as desired. The position of the coolant containers 146 at the lower surface of the double rack permits the cutter 116 at the outlet of the injectors 100 to cut open the container and release the coolant.

Although not readily apparent in this view, a slow burning coating 148 is provided around the solid fuel elements 140 to reduce burn temperatures in the lower regions of the combustion chamber 120. The center portion 150 of the solid fuel body 140 is a faster burning material that increases thrust provided by the engine.

Turning to FIG. 23, the fuel ribbon 102 has a width corresponding to the width of the pinion gears 108. Each of the teeth 142 extends the full width of the ribbon 102 and each of the thin sections 144 likewise is the full width of the ribbon 102. Where the ribbon 102 is part of a wide ribbon body 122, a flange of material may extend laterally to either side of the ribbon 102 after being cut by the cutters 104.

As a modification of the present rocket engine, it is contemplated to use one or more electric motors for some or most of the pumping and pressurization power, for example to drive the pinion gears 108 and other parts. The primary advantage to electric motors is ease of manufacture. Electric motors have a fairly high power to weight ratio, as do batteries, and there is a lot of research to improve both as well.

Although other modifications and changes may be suggested by those skilled in the art, it is the intention of the inventors to embody within the patent warranted hereon all changes and modifications as reasonably and properly come within the scope of their contribution to the art.

I claim:

1. An injector for a solid fuel rocket engine using an elongated fuel body, comprising:
an injector housing defining a fuel passageway;
first and second pinion gears mounted for rotation in said injector housing, said first and second pinion gears being disposed on opposite sides of said fuel passageway so as to engage the fuel body as it passes therebetween, said first and second pinion gears having teeth on their respective outer surfaces to engage teeth on the elongated fuel body;
a cutter mounted at an outlet of said injector housing and disposed to cut into the elongated fuel body as it passes through said fuel passageway.

2. An injector as claimed in claim 1, further comprising:
at least a third and a fourth pinion gear mounted for rotation in said injector housing, said third and fourth pinion gears being disposed on opposite sides of said fuel passageway so as to engage the elongated fuel body downstream of said first and second pinion gears, said third and fourth pinion gears having teeth on their respective outer surfaces to engage teeth of the elongated fuel body.

3. An injector as claimed in claim 2, further comprising:
further pinion gears arranged in pairs downstream of said first and second pinion gears to provide a multiple stage injector.

4. A fuel ribbon for a solid fuel rocket, comprising:
a plurality of fuel bodies disposed in a row, each of said fuel bodies including a tooth shaped portion; and
a covering enclosing said fuel bodies to form an elongated ribbon, said covering forming thin sections between the tooth shaped portions.

5. A fuel ribbon as claimed in claim 4, wherein said fuel bodies include slow burning sections and fast burning sections.

6. A fuel ribbon as claimed in claim 4, further comprising:
a coolant container within ones of said fuel bodies.

7. A fuel ribbon as claimed in claim 4, wherein said fuel bodies each form two oppositely directed tooth shaped portions, said fuel bodies being joined to one another to form a double rack.

8. A fuel ribbon as claimed in claim 4, further comprising:
a plurality of further fuel bodies disposed in a plurality of rows to form side-by-side ribbons; and
a thin section joining the side-by-side ribbons to one another to form a wide ribbon body.

9. A solid fuel rocket engine, comprising:
a plurality of solid fuel ribbons in side-by-side arrangement to form a wide ribbon body, each of said solid fuel ribbons including a plurality of solid fuel elements of a tooth shape, and a covering material covering said solid fuel elements and joining said solid fuel elements into said solid fuel ribbons;
a plurality of ribbon cutters disposed in side-by-side arrangement to cut said wide ribbon body into solid fuel ribbons;
a plurality of injectors disposed to receive the solid fuel ribbons, said plurality of injectors each including a plurality of pairs of opposed gears shaped to engage said solid fuel elements for movement of the solid fuel ribbons along respective ones of said injectors; and
a combustion chamber disposed to receive the solid fuel elements from at least one of said injectors.

10. A solid fuel rocket engine as claimed in claim 9, wherein said solid fuel ribbons are in a shape of a double rack with oppositely directed teeth; and
said injectors include opposed pairs of pinion gears disposed to engage said oppositely directed teeth.

11. A solid fuel rocket engine as claimed in claim 9, further comprising:
coolant containers in said solid fuel ribbon; and
coolant container cutters disposed at an outlet of said injectors and operable to cut open said coolant containers.
